(19) United States
(12) Patent Application Publication
(10) Pub. No.: US 2013/0048742 A1
(43) Pub. Date: Feb. 28, 2013

(54) DUAL PORT PNEUMATIC FITTING APPARATUS

(71) Applicant: Tom Menden, New Berlin, WI (US)

(72) Inventor: Tom Menden, New Berlin, WI (US)

(73) Assignee: Johnson Controls Technology Company

(21) Appl. No.: 13/217,985

(22) Filed: Aug. 25, 2011

(51) Int. Cl. F24F 7/00; F16L 39/00

(52) U.S. Cl. 236/49.3; 285/124.5

(57) ABSTRACT

A dual port pneumatic fitting apparatus for use with a controller for an HVAC system includes a generally planar body having a first surface and a second surface opposite the first surface. The apparatus also includes a first port having an internal passageway extending through the body from the first surface to second surface and a second port having an internal passageway extending through the body from the first surface to the second surface.

### BACKGROUND

The present application relates generally to the field of fittings. The present application more particularly relates to dual port pneumatic fittings for use with a controller for a heating, ventilation, and air conditioning (HVAC) system.

### SUMMARY

One embodiment of the invention relates to a dual port pneumatic fitting apparatus for use with a controller for an HVAC system. The apparatus includes a generally planar body having a first surface and a second surface opposite the first surface. The apparatus also includes a first port having an internal passageway extending through the body from the first surface to second surface and a second port having an internal passageway extending through the body from the first surface to the second surface.

Another embodiment of the invention relates to a controller for an HVAC system. The controller includes a base having at least one wall, the at least one wall having an opening. The controller also includes a circuit board provided within the base and a cover configured to substantially enclose the circuit board within the base. The controller further includes a dual port pneumatic fitting apparatus provided in the opening in the wall of the base.

Another embodiment of the invention relates to a method for manufacturing a controller for an HVAC system. The method includes providing a controller for an HVAC system and coupling a dual port pneumatic fitting apparatus to a base of the controller. The method also includes coupling a first tube between a first connection port of a pressure transducer to a first port of the apparatus and coupling a second tube between a second connection port of the pressure transducer and a second port of the apparatus.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a building with a heating, ventilation, and air conditioning (HVAC) system, according to an exemplary embodiment;

FIG. 2 is a perspective view of a controller having a dual port pneumatic fitting apparatus, according to an exemplary embodiment;

FIG. 3 is a partial exploded view of the controller of FIG. 3, according to an exemplary embodiment;

FIG. 4 is a perspective view of the dual port pneumatic fitting apparatus of FIG. 3, according to an exemplary embodiment;

FIG. 5 is a front view of the controller of FIG. 3, according to an exemplary embodiment;

FIG. 6 is a cross-sectional view of the controller taken along lines 6-6 of FIG. 5, according to an exemplary embodiment;

FIG. 7 is a detailed view of a portion of the controller of FIG. 6 showing a close up of a portion of the dual port pneumatic fitting apparatus, according to an exemplary embodiment;

FIGS. 7A-7B are detailed views of alternative designs of the dual port fitting apparatus, according to various exemplary embodiments; and

FIG. 8 is a flowchart of a method for manufacturing a controller for an HVAC system, according to an exemplary embodiment.

### DETAILED DESCRIPTION OF THE EXEMPLARY EMBODIMENTS

Referring generally to the Figures, a dual port pneumatic fitting apparatus is shown for use within a controller for a heating, ventilation, and air conditioning (HVAC) system. The apparatus includes two integrally formed ports for efficiently and effectively connecting air tubes to aid in the measurement of a differential air pressure within the HVAC system.

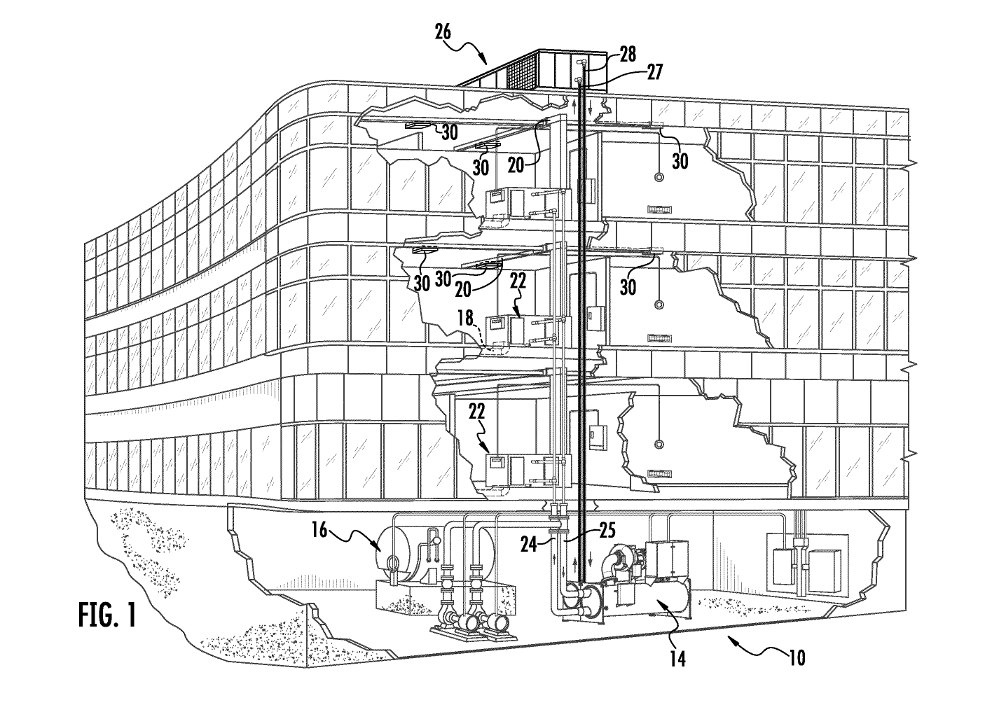

Referring to FIG. 1, a perspective view of a building 10 is shown. The illustration of building 10 includes a cutaway view of an exemplary heating, ventilation, and air conditioning system (HVAC) system. The HVAC system shown in FIG. 1 uses a chilled fluid to remove heat from building 10. The chilled fluid is placed in a heat exchange relationship with the cooling load from the building, usually warm air, via a plurality of air handling units 22. During the heat exchange with the cooling load in air handling units 22, the chilled fluid receives heat from the load (i.e., warm air) and increases in temperature, removing heat from the load (e.g., air passed over piping in fan coil units, air handling units, or other air conditioning terminal units through which the chilled fluid flows). The resulting cooled air is provided from air handling units 22 to building 10 via an air distribution system including air supply ducts 20 and air return ducts 18. The HVAC system shown in FIG. 1 includes a separate air handling unit 22 on each floor of building 10, but components such as air handling unit 22 or ducts 20 may be shared between or among multiple floors. Boiler 16 can add heat to the air passing through air handling units 22 when conditions exist to warrant heating.

The chilled fluid is no longer chilled after receiving heat from the load in air handling units 22. To re-chill the fluid for recirculation back to the air-handling units, the fluid is returned to a chiller 14 via piping 25. Within chiller 14, the fluid is placed in a heat exchange relationship with another cooling fluid, usually a refrigerant, in the chiller's heat exchanger (e.g., an evaporator). The refrigerant in the chiller's evaporator removes heat from the chilled fluid during the evaporation process, thereby cooling the chilled fluid. The chilled fluid is then circulated back to the air handling units 22 via piping 24 for subsequent heat exchange with the load, and the cycle repeats.

The refrigerant in chiller 14 that absorbs heat from the chilled fluid changes from a boiling liquid and vapor state to vapor in the evaporator. The vapor is sucked or flows into a compressor of chiller 14 where the compressor's rotating impeller (or another compressor mechanism such as a screw compressor, scroll compressor, reciprocating compressor, centrifugal compressor, etc.) increases the pressure and temperature of the refrigerant vapor and discharges it into the condenser. The condensed refrigerant drains from the condenser into a return line where a variable orifice (e.g., variable expansion valve) meters the flow of liquid refrigerant to the evaporator to complete the refrigerant circuit.

In the embodiment of FIG. 1, water (or another chilled fluid) flows through tubes in the condenser of chiller 14 to absorb heat from the refrigerant vapor and causes the refrigerant to condense. The water flowing through tubes in the condenser is pumped from chiller 14 to a cooling tower 26 via piping 27. Cooling tower 26 utilizes fan driven cooling of the water or fan driven evaporation of the water to remove heat from the water delivered to cooling tower 26 via piping 27. The water cooled by cooling tower 26 is provided back to chiller 14's condenser via piping 28.

To ensure proper air flow to each zone of the HVAC system, controllers 30 may be provided at certain locations throughout the building (e.g., as shown in FIG. 1). According to an exemplary embodiment, each controller 30 includes a differential pressure sensor and an actuator (e.g., to control a damper within the supply or return ducts). The differential pressure sensor is used to measure the difference in pressures of specific air volumes within the HVAC system. Based on measurements obtained by the differential pressure sensor (and other various parameters), the controller may activate the damper to open or close based on the specific requirements of the system.

The controller 30 can be supervised by one or more building management system (BMS) controllers (not shown). A BMS controller is, in general, a computer-based system configured to control, monitor, and manage equipment in or around a building or building area. A BMS controller may include a METASYS building controller or other devices sold by Johnson Controls, Inc. The BMS controller may provide one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with the BMS, its subsystems, and devices.

For example, the BMS controller may provide a web-based graphical user interface that allows a user to set a desired setpoint temperature for a building space. The BMS controller can use BMS sensors (connected to the BMS controller via a wired or wireless BMS or IT network) to determine if the setpoint temperatures for the building space are being achieved. The BMS controller can use such determinations to provide commands to the controller or other components of the building's HVAC system.

Referring now to FIGS. 2-7, the controller 30 for use with the HVAC system of FIG. 1 is shown according to an exemplary embodiment. As shown in FIG. 2, the controller 30 includes a bottom portion or base 34, a top portion or cover 32 and a fitting 60 shown as a dual port pneumatic fitting apparatus. As shown in FIG. 3, a controller 30 also includes a circuit board 50 that is provided within the base 34 and cover 32. The circuit board 50 includes, among other components, a pressure transducer 52 having connection ports 54 extending out from a surface of the pressure transducer 52.

According to an exemplary embodiment, the pressure transducer 52 is configured to measure the differential pressure of two air volumes within the HVAC system. As such, a first tube or hose 36 is connected to one of the connection ports 54 of the pressure transducer 52 and a second tube or hose 36 is connected to a second one of the connection ports 54 of the pressure transducer 52. According to one exemplary embodiment, the pressure transducer 52 is a digital pressure transducer. However, according to another exemplary embodiment, the pressure transducer 52 is an analog pressure transducer.

To aid in connecting the tube or hose 36 from the pressure transducer 52 to the specific air volumes to be measured within the HVAC system, the fitting 60 is provided in an opening 48 in a wall 42 of the base 34 of the controller 30. As shown in FIG. 3, according to an exemplary embodiment, the cover 32 includes a tab 38 shown as a projection or protrusion extending from a wall 40 of the cover 32. A portion of the tab 38 contacts a top portion or surface of the fitting 60 to aid in holding the fitting 60 within the opening 48 of the base 34. According to an exemplary embodiment, the tab 38 helps to securely hold the fitting 60 in place (such as, e.g., shown in FIG. 5).

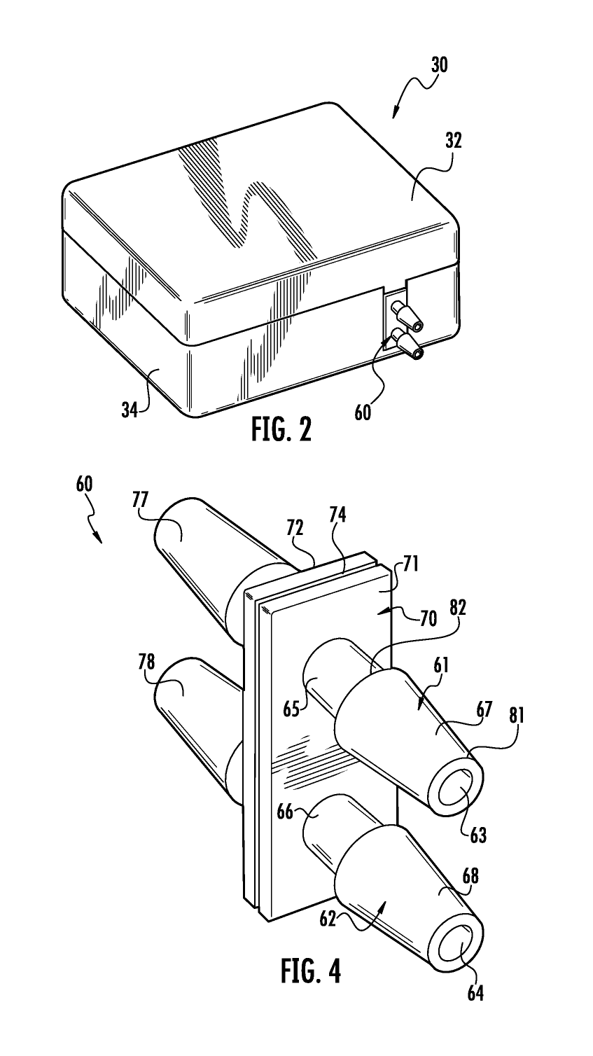

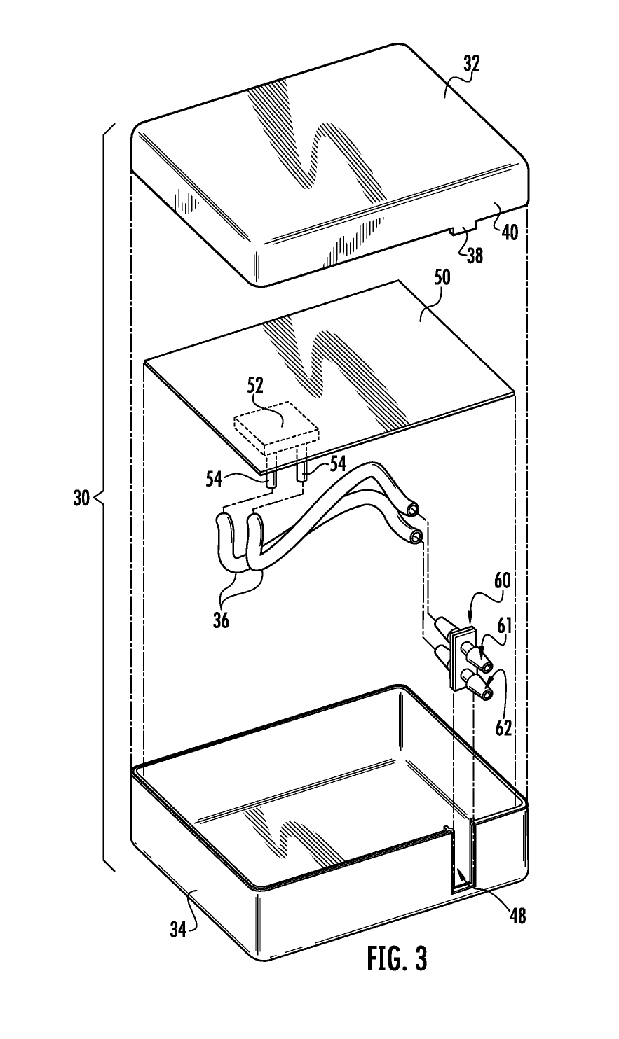

Referring to FIG. 4, the fitting 60 is shown according to an exemplary embodiment. The fitting 60 includes a body 70 (e.g., bulkhead, portion, member, etc.) having a first or external side or surface 71 and a second or internal side or surface 72 opposite of the first surface 71. An edge or surface is formed between the surfaces 71, 72 and includes a groove or slot 74. According to an exemplary embodiment, the groove 74 is configured to receive a corresponding feature of the opening 48 of the base 34 to aid in coupling the fitting within the controller 30. As shown in FIG. 4, the body 70 has a generally planar shape having a generally rectangular cross-section. However, according to other exemplary embodiments, the body 70 may have a different shape or may be otherwise configured.

According to an exemplary embodiment, the fitting 60 includes a first port 61 and a second port 62. The first port 61 includes an internal passage that extends through the body 70 of the fitting 60 to connect the first surface 71 to the second surface 72. Likewise, the second port 62 includes an internal passageway 64 connecting the first surface 71 to the second surface 72 of the body 70. In other words, an exterior side (i.e., outside the controller) of the fitting 60 is in fluid communication with an internal side (i.e., inside the controller) of the fitting 60 via the internal passages 63, 64. As shown in FIG. 4, according to an exemplary embodiment, each internal passage 63, 64 has a generally circular cross-section. However, the internal passages 63, 64 may be otherwise shaped or configured according to other exemplary embodiments.

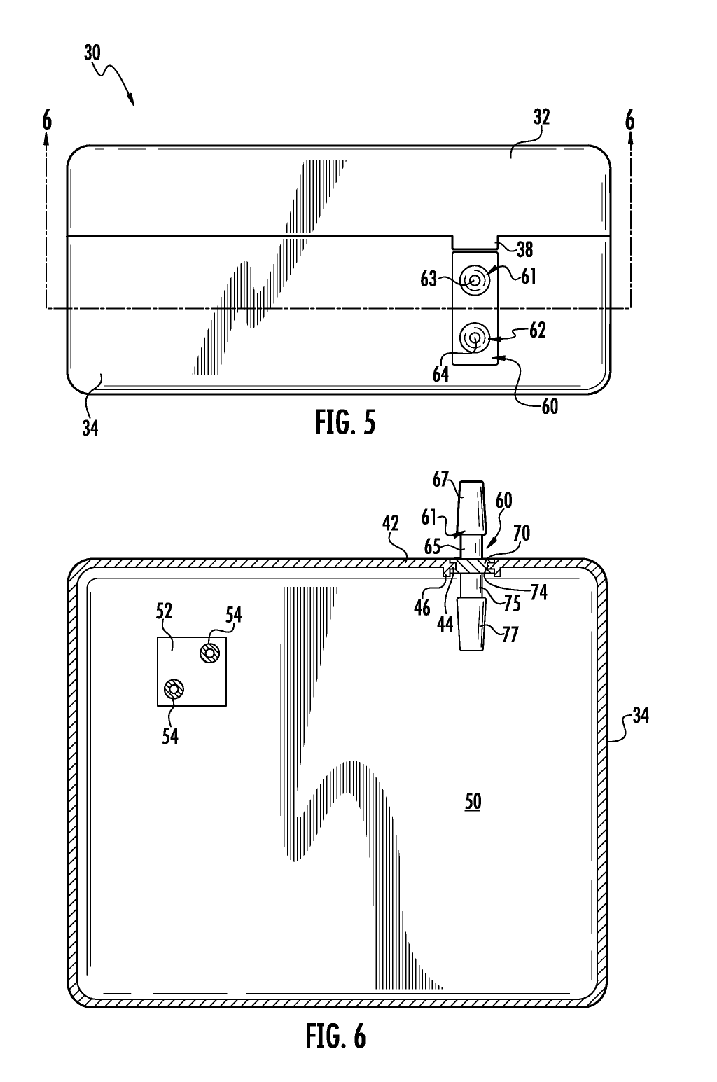

As shown in FIG. 4, each port 61, 62 includes a first extension 65, 66 extending out from the first surface 71 of the body 70 and a second extension (e.g., extension 75 as shown in FIG. 6) extending out from the second surface 72 of the body 70. Each extension includes a barb (such as, e.g., barbs 67, 68, 77, 78 as shown in FIG. 4) coupled at the opposite end of the extension. According to an exemplary embodiment, each barb has a first end (e.g., first end 81 as shown in FIG. 4) and a second end (e.g., second end 82 as shown in FIG. 4) opposite the first end. As shown in FIG. 4, each barb includes tapered shape from the first end to the second end of the barb. For example, as shown in FIG. 4, the first end of the barb has a diameter that is smaller than the diameter at the second end of the barb. Further, since the diameter at the second of the barb is larger than an external diameter of the extension, a feature or a shoulder is created between the end of the extension and the second end of the barb. According to an exemplary embodiment, the feature or shoulder is configured to aid in securing the end of a tube or hose that is provided over the barb.

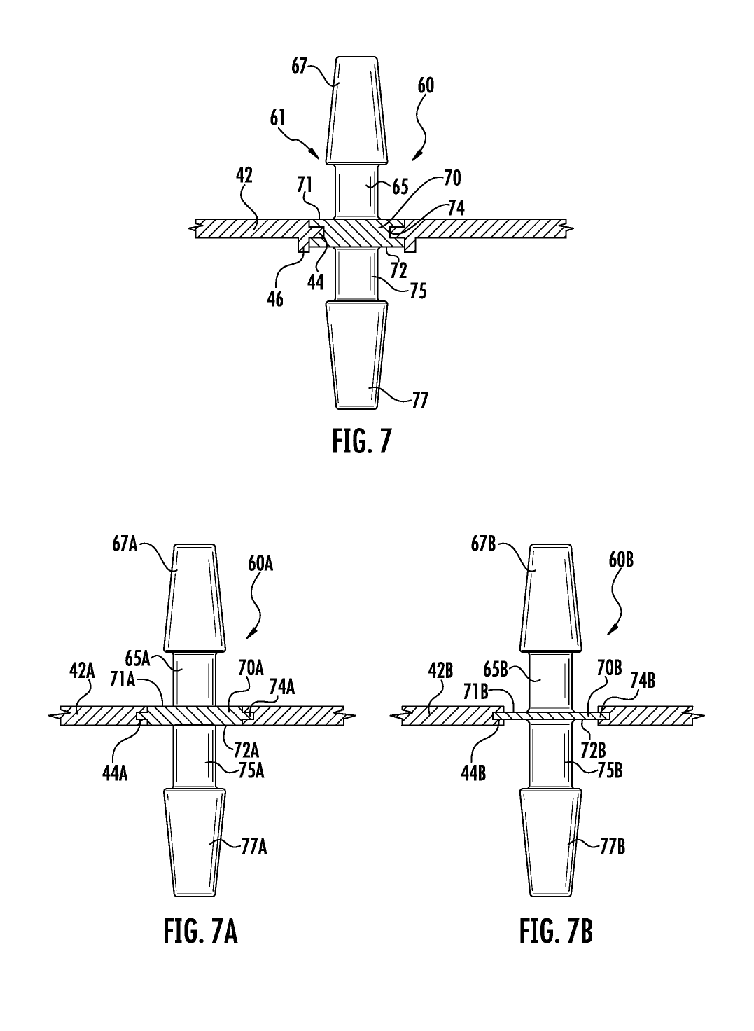

Referring now to FIGS. 7-7B, various exemplary embodiments of how the fitting 60 is coupled to or received within the opening 48 of the wall 42 of the base 34 are shown. It is noted that FIGS. 7A-7B show generally similar elements to those shown in FIG. 7, with similar elements shown in FIGS. 7A-7B having an “A” or “B” suffix, respectively. For example, FIG. 7 shows body 70 having a groove or slot 74 that is configured to receive a projection or protrusion 44 (e.g., extension, member, etc.). As such, fitting 60 may be slid into the opening 48 such that the groove 74 surrounds the projection 44 to aid in retention of the fitting 60 within the opening 48 of the base 34 of the controller 30. It is also noted that the wall 42 of the base 34 includes a projection or end wall 46 that aids in securing the body 70 within the opening 48 of the wall 42. However, according to another exemplary embodiment, this projection 46 may be excluded from the design.

Referring to FIG. 7A, according to an exemplary embodiment, the wall 42A includes a slot or a groove 44A that is configured to receive a projection or protrusion 44A of the body 70A of the fitting 60A. As such, the projection 74A is received by the groove 44A when the fitting 60A is provided or slid into the opening of the wall 42A. It is also noted that the embodiment shown in FIG. 7A does not include an end wall projection similar to the end wall projection 46 shown in FIG. 7.

Referring to FIG. 7B, the wall 42B includes a slot or groove 44B similar to the slot or groove 44A shown in FIG. 7A. The groove 44B is configured to receive an end portion 74B of the body 70B of the fitting 60B. As such, the design and construction of the body 70B of the fitting 60B is much simpler than that shown in either of FIG. 7 or 7A.

It should be noted that the various designs of the interaction between the fitting and the base of the controller shown in FIGS. 7-7B show only a few representative examples, and that one of ordinary skill in the art would readily appreciate that many more configurations are possible.

One advantage of the designs shown in FIGS. 2-7B is that the fitting captures and organizes the tubing from the differential pressure transducer within the controller by using only a single fitting with two pass-through ports, all in a compact space. Further, the fitting provides strain relief for the pressure transducer in that tubing from the air volumes being measured are not directly coupled to the pressure transducer. In other words, stresses or vibrations imparted on the tubing coming from the air volumes to be measured are not imparted on the pressure transducer within the controller. Instead, the fitting eliminates any such stresses or strains. For example, if the tubing outside of the controller were to be pulled or grabbed, the tubing would simply come off of the external side of the fitting, while the internal connections (from the pressure transducer to the internal side of the fitting) would remain connected.

The fitting also provides an organized connection point for the tubing which is to be routed to the air volumes to be measured. As such, tubing running from the air volumes to be measured can be quickly and efficiently coupled to the controller by the use of the single fitting. As such, the differential pressure of the air volumes can be measured and then input into a control algorithm (e.g., such as a control algorithm of the controller) for control of a damper or other component of the HVAC system.

By having the single fitting, the tubing is prevented from being pulled off of the pressure transducer within the controller. Thus, if tubing from the air volumes to be measured is disturbed (i.e., pulled off of the fitting), the tubing simply can be reinserted on to the external barbs of the fitting rather than having to open up the controller and reinstall the tubing on to the pressure transducer. Further, damage to the pressure transducer is prevented in that the pressure transducer is not affected by disturbances to the tubing external the controller.

Another advantage of the fitting is that the fitting prevents the rotation of the individual tubes used to connect the pressure transducer to the air volumes subject to measurement. As with previous designs, each of the tubing lines are run from the subject air volumes to the pressure transducer. Thus, any movement, such as rotation of the tubing, would be imparted directly to the pressure transducer. As such, the rotation of the tubing could cause the pressure transducer to break and/or fail. However, with the fitting of FIGS. 2-7B, the pressure transducer is kept independent and separate from the tubing connected to the air volumes being measured, thus protecting and securing the pressure transducer from failure.

Having a single fitting also decreases the number of parts and components needed to build a controller. For example, an integrally formed dual port fitting can replace two separate and independent single port fittings. Having a smaller number of parts saves money in that fewer parts need to be manufactured and tracked during the assembly process. Additionally, having the single fitting aids in more quickly assembling the controller as only the single fitting needs to be installed with the controller, as opposed to multiple fittings used in previous designs. Thus, time and money can be saved when manufacturing and assembling the controller using the fitting shown in FIGS. 2-7B.

According to an exemplary embodiment, the fitting and other components of the controller may be manufactured from any suitable materials. For example, the fitting may be manufactured from a hard plastic. It should be noted that the construction and/or arrangement of the fitting for use with the controller may be modified. For example, instead of the generally vertical orientation of the fitting as shown if FIGS. 2-7B, the fitting may have a generally horizontal orientation or configuration. For example, instead of the ports being on top or above one another, the ports may be configured side-by-side one another.

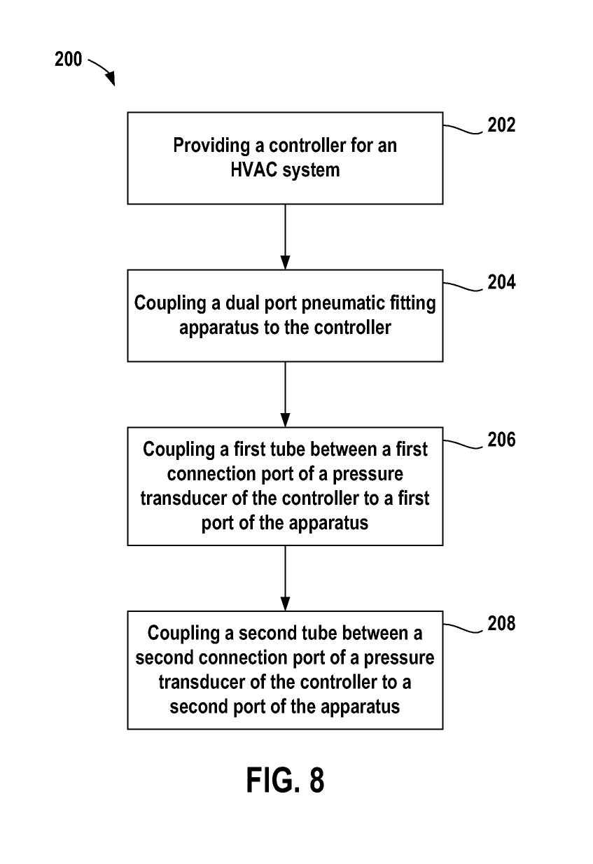

Referring now to FIG. 8, a flowchart of a method 200 for manufacturing a controller for an HVAC system is shown according to an exemplary embodiment. As shown in FIG. 8, method 200 includes a first step 202 of providing a controller for an HVAC system. Method 200 also includes a second step 204 of coupling a dual port pneumatic fitting apparatus to the controller. A third step 206 includes coupling a first tube between a first connection port of a pressure transducer of the controller to a first port of the apparatus. Finally, a fourth step 208 includes coupling a second tube between a second connection port of a pressure transducer of the controller to a second port of the apparatus.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

Although the figures may show a specific order of method steps, the order of the steps may differ from what is depicted. Also two or more steps may be performed concurrently or with partial concurrence. Such variation may depend on the components and hardware systems chosen and/or on designer choice. All such variations are within the scope of the disclosure.

What is claimed is:

1. A dual port pneumatic fitting apparatus for use with a controller for an HVAC system, the apparatus comprising:
a generally planar body having a first surface and a second surface opposite the first surface;
a first port having an internal passageway extending through the body from the first surface to second surface; and
a second port having an internal passageway extending through the body from the first surface to the second surface.

2. The apparatus of claim 1, wherein the body has a generally rectangular shaped cross-section.

3. The apparatus of claim 1, wherein an edge of the body has a feature for coupling the apparatus with the controller of the HVAC system.

4. The apparatus of claim 3, wherein the feature is a groove.

5. The apparatus of claim 1, wherein each of the first and second ports has a first extension that extends out from the first surface of the body and a second extension that extends out from the second surface of the body.

6. The apparatus of claim 5, wherein each extension has a generally cylindrical shape.

7. The apparatus of claim 5, wherein each extension comprises a barb coupled to an end of the extension.

8. The apparatus of claim 7, wherein the barb comprises a first end and a second end opposite the first end, wherein a diameter of the first end is smaller than a diameter of the second end.

9. The apparatus of claim 8, wherein the diameter of the second end of the barb is larger than an external diameter of the extension the barb is coupled to to form a shoulder between the second end of the barb and the extension.

10. A controller for an HVAC system comprising:
a base having at least one wall, the at least one wall having an opening;
a circuit board provided within the base;
a cover configured to substantially enclose the circuit board within the base; and
a dual port pneumatic fitting apparatus provided in the opening in the wall of the base, the apparatus comprising:
a body having a first surface and a second surface opposite the first surface;
a first port having an internal passageway extending through the body from the first surface to second surface; and
a second port having an internal passageway extending through the body from the first surface to the second surface.

11. The controller of claim 10, wherein the cover has a feature configured to aid in securing the apparatus within the opening in the wall of the base.

12. The controller of claim 10, wherein one of the opening of the wall of the base and the body of the apparatus comprises a projection and the other one of the opening of the wall of the base and the body of the apparatus comprises a groove for receiving the projection to aid in coupling the apparatus within the opening of the wall of the base.

13. The controller of claim 10, wherein the circuit board comprises a pressure transducer comprising a first connection port and a second connection port.

14. The controller of claim 13, wherein a first tube connects the first connection port of the pressure transducer to the first port of the apparatus and a second tube connects the second connection port of the pressure transducer to the second port of the apparatus.

15. The controller of claim 10, wherein each of the first and second ports has a first extension that extends out from the first side of the body and a second extension that extends out from the second surface of the body.

16. The controller of claim 15, wherein each extension has a generally cylindrical shape.

17. The controller of claim 15, wherein each extension comprises a barb coupled to an end of the extension.

18. The controller of claim 17, wherein the barb comprises a first end and a second end opposite the first end, wherein a diameter of the first end is smaller than a diameter of the second end.

19. The controller of claim 18, wherein the diameter of the second end of the barb is larger than an external diameter of the extension the barb is coupled to to form a shoulder between the second end of the barb and the extension.

20. A method for manufacturing a controller for an HVAC system, the method comprising:
providing a controller for an HVAC system, the controller comprising:
a base having at least one wall, the at least one wall having an opening;
a circuit board provided within the base, the circuit board comprising a pressure transducer; and
a cover configured to substantially enclose the circuit board within the base;
coupling a dual port pneumatic fitting apparatus to the base of the controller, the apparatus comprising:
a generally planar body having a first surface and a second surface opposite the first surface;
a first port having an internal passageway extending through the body from the first surface to second surface; and
a second port having an internal passageway extending through the body from the first surface to the second surface;
coupling a first tube between a first connection port of the pressure transducer to the first port of the apparatus; and
coupling a second tube between a second connection port of the pressure transducer and the second port of the apparatus.
